(19) United States
(12) Patent Application Publication
(10) Pub. No.: US 2007/0166481 A1
(43) Pub. Date: Jul. 19, 2007

(54) In-situ UV curing of media lubricants

(75) Inventors: Michael Joseph Stirniman, Fremont, CA (US); Jianwei Liu, Fremont, CA (US)

Correspondence Address: SEAGATE TECHNOLOGY c/o MOFO NOVA, 1650 TYSONS BOULEVARD, SUITE 300, MCLEAN, VA, 22102, US

(73) Assignee: SEAGATE TECHNOLOGY LLC, Scotts Valley, CA (US)

(21) Appl. No.: 11/331,340

(22) Filed: Jan. 13, 2006

(51) Int. Cl. B05D 5/12; B05D 5/06; B05D 3/00; C08J 7/18

(52) U.S. Cl. 427/553; 427/127; 427/294; 427/162

(57) ABSTRACT

A system having a deposition chamber comprising a xenon excimer lamp and an inlet for deposition of a lubricant into the deposition chamber, wherein the deposition chamber has an ability to perform both a vapor deposition of the lubricant and an in-situ UV exposure of the lubricant is disclosed. Also, a method including depositing a lubricant on a magnetic recording medium in a deposition chamber and in-situ UV exposing of the lubricant to irradiation from a xenon excimer lamp is disclosed.

### FIELD OF THE INVENTION

The present invention relates to a recording media having an advanced lubricant for thin film storage medium, wherein the advanced lubricant is manufactured by in-situ UV curing.

### BACKGROUND

Magnetic discs with magnetizable media are used for data storage in most all computer systems. Current magnetic hard disc drives operate with the read-write heads only a few nanometers above the disc surface and at rather high speeds, typically a few meters per second. Because the read-write heads can contact the disc surface during operation, a layer of lubricant is coated on the disc surface to reduce wear and friction.

FIG. 1 shows a disk recording medium and a cross section of a disc showing the difference between longitudinal and perpendicular recording. Even though FIG. 1 shows one side of the non-magnetic disk, magnetic recording layers are sputter deposited on both sides of the non-magnetic aluminum substrate of FIG. 1. Also, even though FIG. 1 shows an aluminum substrate, other embodiments include a substrate made of glass, glass-ceramic, NiP/aluminum, metal alloys, plastic/polymer material, ceramic, glass-polymer, composite materials or other non-magnetic materials.

The lubricant film on hard discs provides protection to the underlying magnetic alloy by preventing wear of the carbon overcoat. In addition, it works in combination with the overcoat to provide protection against corrosion of the underlying magnetic alloy. The reliability of hard disks depends on the durability of the thin film media. As the spacing between head disk is being reduced aggressively to improve area storage density, media are facing many severe technical obstacles, such as weak durability, heavy lubricant pickup by the read-write head, unmanageable stiction/friction, etc. Lubrication plays unquestionably an important role in overcoming these technical difficulties.

Lubrication additive moieties, such as Bis(4-fluorophenoxy)-tetrakis(3-trifluoromethyl phenoxy) cyclotriphosphazene (X1-p) can improve tribological performance and corrosion resistance of thin film media. Generally, the lubricant is applied to the disc surface by dipping the disc in a bath containing the lubricant. The bath typically contains the lubricant and a coating solvent to improve the coating characteristics of the lubricant, which is usually viscous oil. The discs are removed from the bath, and the solvent is allowed to evaporate, leaving a layer of lubricant on the disc surface. The amount of lubricant moieties and additive moieties adsorbed on the disk overcoat is controlled by varying the solution concentration and the drain rate. However, it is desirable to increase the degree of chemical interaction between the lubricant and the media to provide improved lubrication performance of the media during long-term, repeated use of the media.

### SUMMARY OF THE INVENTION

The embodiments of the invention relate to a system comprising a deposition chamber comprising a xenon excimer lamp and an inlet for deposition of a lubricant into the deposition chamber, wherein the deposition chamber has an ability to perform both a vapor deposition of the lubricant and an in-situ UV exposure of the lubricant. Preferably, the system further comprises a source chamber, wherein the source chamber communicates with the deposition chamber. Preferably, the xenon excimer lamp produces more than 25% of the power at a wavelength of 185 nm or less. Preferably, the xenon excimer lamp operates under a vacuum. Preferably, the system does not include purging with a coolant to cool the xenon excimer lamp. Preferably, the deposition chamber is under a vacuum.

Other embodiments of the invention relate to a method comprising depositing a lubricant on a magnetic recording medium in a deposition chamber and in-situ UV exposing of the lubricant to irradiation from a xenon excimer lamp. Preferably, the method further comprises providing the lubricant from a source chamber to the deposition chamber, wherein the source chamber communicates with the deposition chamber. Preferably, the method further comprises evacuating the deposition chamber and the source chamber with a vacuum source to a pressure below atmospheric. Preferably, the method further comprises heating the lubricant in the source chamber so that the pressure in the source chamber is greater than the pressure in the deposition chamber. Preferably, the depositing the lubricant on the magnetic recording medium in the deposition chamber comprises exposing the magnetic recording medium in the deposition chamber to the lubricant for a time sufficient to deposit the lubricant topcoat on the surface of the magnetic recording medium. Preferably, the depositing the lubricant on the magnetic medium in the deposition chamber is at a pressure no greater than about 100 Torr. Preferably, the method further comprises heating the lubricant in the source chamber and comprising controlling the flow of the lubricant between the source chamber and the deposition chamber with a controller valve. Preferably, the xenon excimer lamp produces more than 35% of the power at a wavelength of 185 nm or less.

Yet other embodiments of the invention relate to a method comprising irradiating a lubricant film with UV radiation emitted from a xenon excimer lamp and having a wavelength corresponding to a wavelength of maximum absorption of UV radiation by the lubricant film, wherein the lubricant thin film comprises at least one perfluoropolyether compound and a phosphazene derivative. Preferably, the lubricant thin film is formed on a surface of a data/information storage and retrieval medium. Preferably, the data/information storage and retrieval medium is a disk-shaped magnetic or magneto-optical (MO) recording medium. Preferably, the medium comprises a layer stack formed on a substrate surface, the layer stack including an uppermost, carbon (C)-containing protective overcoat layer, and the lubricant thin film is in the form of a topcoat layer in overlying contact with the carbon (C)-containing protective overcoat layer. Preferably, the phosphazene derivative is bis (4-fluorophenoxy)-tetrakis (3-trifluoromethyl phenoxy) cyclo-triphosphazene. Preferably, the method could further comprise varying the wavelength of maximum absorption of UV radiation by the lubricant thin film by varying the temperature of the lubricant thin film during the irradiation.

Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention a property of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

The present invention will be better understood by reference to the Detailed Description of the Invention when taken together with the attached drawings, wherein:

FIG. 1 shows a magnetic recording medium.

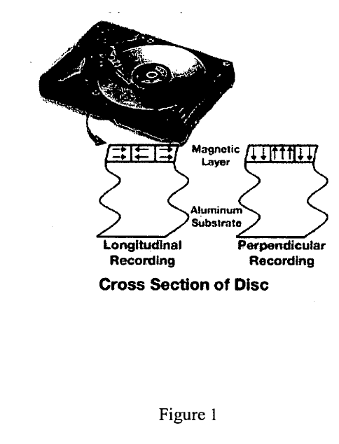

FIG. 2 shown an inline process for manufacturing magnetic recording media.

FIG. 3 shows the chemical structure of the invented lubricants, in which B are the bonding enhancing chemical groups, including hydroxyl, 2,3-dihydroxy-1-propoxyl and Acetamide.

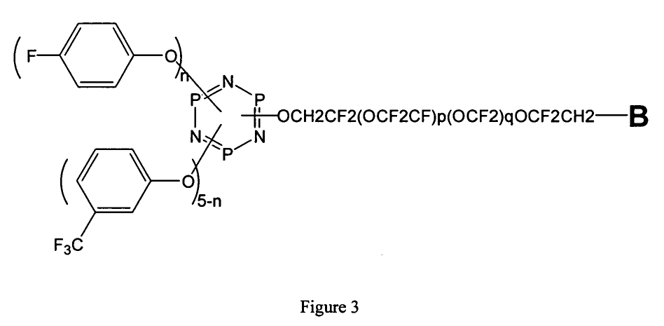

FIG. 4 shows a hydroxyl end-group of a PFPE lubricant moiety combine with an activated cyclotriphosphazene ring moiety to form a photosynthesized lubricant molecule.

FIG. 5 shows a diagram of a typical Xenon excimer UV lamp (from Xeradex lamp marketing brochure, Osram GmbH).

FIG. 6 shows a bonded lubricant vs. time for a mercury discharge lamp and a xenon excimer lamp, both at ambient pressure under nitrogen.

FIG. 7 a schematic of the accepted physical mechanism of UV bonding of lubricant.

### DETAILED DESCRIPTION OF THE INVENTION

The invention is directed to a method of coating a substrate, particularly recording media (recording discs), with a lubricant, which is also referred in the specification to as a “lube.” Lubricants typically are liquid perfluoropolyethers and contain molecular weight components that range from several hundred Daltons to several thousand Daltons.

Ultraviolet (UV) light has been widely used in the disk drive industry to increase the chemical interactions between media lubricants and media carbon overcoats. These increased interactions are generally described by the widely used but chemically imprecise industry term “bonded lubricant.” By this terminology, the bonded lubricant fraction refers to the percentage of the total lubricant film that remains on the carbon overcoat after some standardized solvent wash procedure. After the UV exposure of a lubricant film, the fractional amount of the total lubricant that is bonded is typically seen to increase, sometimes dramatically. The amount of increase depends on a number of factors, including the UV exposure time, the UV power density at the disk surface, the UV wavelength, the lubricant type and initial thickness, and the exposure environmental conditions such as temperature and oxygen partial pressure. The oxygen partial pressure is considered to be a particularly relevant parameter, due to the ability of UV photons with sufficiently high energy to break the O₂ bond and create the corrosive gas ozone during the cure process.

UV curing could be done by using mercury discharge lamps, but such a process could suffer from a number of drawbacks as has been recognized by the inventors. Foremost, mercury discharge lamps could lose power over their lifetime, require a long warm-up time and continuous operation, run at high temperatures, and could be environmentally undesirable.

The UV process depends strongly on the UV photon energy. In the case of the mercury discharge UV lamp, it generates only a small fraction (<15%) of its total output at the useful wavelength of 185 nm with a photon energy of 6.7 eV, with the main fraction of the power being consumed at the less useful 254 nm wavelength with a photon energy of 4.9 eV.

The relatively low useful output of the UV lamps translates into longer cure times to achieve the desired film properties, and large numbers of lamps could be needed to achieve the throughput of a high-volume manufacturing process. In addition to losing total power over time, the relative fraction of the lamp's power at 185 nm could also decrease over time, making process control difficult, and the lamp's power output and rate of power loss could be a function of the lamp temperature. UV curing is generally done at ambient pressure in dedicated tools, which are heavily purged with dry nitrogen to prevent ozone formation and help cool the lamps. The tools are expensive and occupy a considerable amount of expensive clean-room floor space, and the nitrogen purge required to prevent ozone formation is likewise quite expensive. Further, the nitrogen purge could be inefficient, resulting in residual ozone in the UV chamber. Finally, although 185 nm UV is not energetic enough to break the N₂ triple bond, the ambient nitrogen purge gas could attenuate the UV power at the disk surface and further reduce the curing efficiency. Furthermore, the attenuation is a function of the lamp-to-disk spacing, which could become another process variable.

On the other hand, a Xenon excimer UV lamp produces UV light at the useful wavelength of 172 nm with a photon energy of 7.2 eV. At this high energy, the 172 nm UV photon has energy high enough to break many chemical bonds. While not being limited by description on how the Xenon excimer UV lamp works, it is believed that excitation of Xenon atoms (Xe) by electrons form excited Xenon atoms (Xe*). The excited Xe* atoms react in a three body collision to form an Xe₂* excimer complex which radiates at 172 nm. This excimer system can be pumped at very high power densities (>1 MW/cm²) and is not subjected to self-absorption because the excimer has no stable ground state.

In light of the above recognition of the problems of using a mercury discharge lamp and the benefits of using an excimer UV lamp for UV curing of lubricants, an embodiment of this invention relates to UV curing with high efficiency excimer ultraviolet lamps to reduce or eliminate the drawbacks inherent with the mercury discharge lamps and ambient process, through incorporation of the lamps as a vacuum in-situ process step in conjunction with a vacuum in-situ vapor deposition of lubricant. “In situ” means that the media was processed during the manufacturing process without removing the media from a chamber to a separate location to perform a process step to which the term “in situ” refers to.

Preferably, the vapor deposition on the media and the subsequent exposure of the media to the excimer UV lamp could be done in the same chamber, and furthermore preferably without moving the media between the steps of the vapor deposition and UV exposure from the excimer UV lamp.

In the embodiments of the invention, the same chamber for both in-situ vapor deposition and UV exposure of the lubricant could be as follows. Embodiments of the present invention comprise suspending a magnetic recording medium in a deposition chamber and providing a lubricant in a source chamber as in U.S. Pat. Nos. 6,214,410, and 6,183,831, which are incorporated herein by reference. The deposition and source chambers can be constructed of any material which will function at sub-atmospheric pressures and does not interfere with the deposition process, and does not adversely affect the desired properties of the resulting product, e.g. glass, ceramic or metal. A vacuum source could be employed to evacuate the deposition and source chambers to a pressure below atmospheric pressure, e.g. a pressure less than about 760 Torr. The temperature of the lubricant in the source chamber, i.e., the chamber which is the source of the lubricant supplied to the deposition chamber, could be then elevated above the temperature of the magnetic recording medium in the deposition chamber, which elevated temperature causes vaporized lubricant in the source chamber to flow from the source chamber to the deposition chamber and condense on a surface of the magnetic recording medium to form a lubricant topcoat. After sufficient time has elapsed to deposit a topcoat having a substantially uniform thickness substantially completely covering the surface of the recording medium, the deposition chamber can be vented to the atmosphere, or vented with a desired gas. The magnetic recording medium could then be in-situ UV treated in the same deposition chamber, and finally removed.

In accordance with embodiments of the present invention, the deposition and source chambers can be evacuated substantially concurrently to substantially the same relative pressure of about 100 Torr to about 10⁻¹⁰ Torr. After evacuating the deposition and source chambers to the desired pressure, the source chamber can be isolated from the deposition chamber and the vacuum source employing a conventional valve. Subsequent heating of the lubricant in the source chamber causes the pressure in the source chamber to increase relative to the pressure in the deposition chamber. By then opening the valve, lubricant vapor in the source chamber will flow from the source chamber to the deposition chamber. Since the deposition chamber is at a lower temperature and pressure, the heated lubricant from the source chamber deposits on the magnetic recording medium within the deposition chamber. The valve is opened for a period of time sufficient to deposit the lubricant topcoat at a desired uniform thickness. Thereafter, the valve is closed, the deposition chamber vented, the recording medium removed and the method steps repeated.

In an embodiment of the present invention, the vacuum source can be isolated from the apparatus employing another valve positioned between the vacuum source and the apparatus. By closing such a valve, the vacuum source can be isolated from the deposition chamber prior to exposing the magnetic recording medium to lubricant vapor in the deposition chamber. Practical considerations may require application of the vacuum to the deposition chamber during which the lubricant is heated in the source chamber and to ensure an adequate pressure differential between the two chambers. An embodiment of the present invention includes the use of a valve between the deposition chamber and the vacuum source.

According to the present invention, it is understood that the deposition of a lubricant topcoat on a surface of a magnetic recording medium at sub-atmospheric pressure yields improved control over the deposited topcoat layer. The amount, quality and molecular weight of the lubricant vapor which flows from the source chamber to the deposition chamber is dependent upon the relative pressure difference and the relative temperature difference between the two chambers.

It is particularly effective to reduce the pressure in the deposition chamber to within the range of about 10 Torr to about 10⁻¹⁰ Torr, e.g., within the range of about 10⁻³ Torr to about 10⁻⁹ Torr. Further, by elevating the temperature of the lubricant in the source chamber, the pressure of the source chamber is increased relative to the deposition chamber. Embodiments of the present invention include elevating the temperature of the lubricant in the source chamber to greater than about 35° C. but less than about 300° C., e.g., a temperature within the range of about 120° C. to about 220° C. By elevating the temperature of the lubricant in the source chamber, the pressure in the source chamber is also elevated. Embodiments of the present invention include evacuating the source chamber to a pressure of about 700 Torr to about 10⁻⁵ Torr, e.g., about 100 Torr to about 0.01 Torr

Irradiation of media is could be achieved through the use of an irradiation apparatus comprising the deposition chamber. In such an irradiation process, discs could placed on a saddle and lifted individually into a space between two ultraviolet lamps in a dedicated process chamber.

To be of practical use, an in-situ UV cure process requires vacuum compatible UV lamps that output high enough power at high enough photon energy to effect curing in times on the order of 10 seconds or less. Excimer UV lamps output a single high-energy wavelength (e.g., 172 nm) at power densities of about 50 mW/cm², with an energy conversion efficiency of around 40%. This compares to the typical total power output of 20-30 mW/cm² from a mercury discharge lamp, only 3-5 mW/cm² or less of which is at the useful wavelength of 185 nm, and which operate at much lower conversion efficiencies. The excimer lamp can also be manufactured with vacuum compatible components, which is difficult to achieve with mercury discharge lamps. Excimer lamps use environmentally benign xenon as the working gas, eliminating the hazards associated with mercury. Finally, excimer lamps run considerably cooler than mercury discharge lamps, and no external cooling is required.

Operating the excimer lamp in vacuum simultaneously eliminates both the need for nitrogen purge and the generation of ozone during the process. If on the other hand ozone is in fact found to be of benefit, it could be incorporated into the process in a controlled manner by back filling the deposition chamber with oxygen. The in-situ UV process in conjunction with vapor deposition of lubricant eliminates the need for external UV curing tools and their associated floor space and handling steps. The vacuum process using the excimer lamp is additionally more efficient than the UV process using the mercury discharge lamp as it eliminates the attenuation of the UV power by ambient nitrogen. Unlike mercury discharge lamps, which require long warm-up times and need to be run continuously to maintain a steady output, excimer lamps require less than 1 second warm up time to reach full power, and thus can be turned on and off as part of the in-situ process.

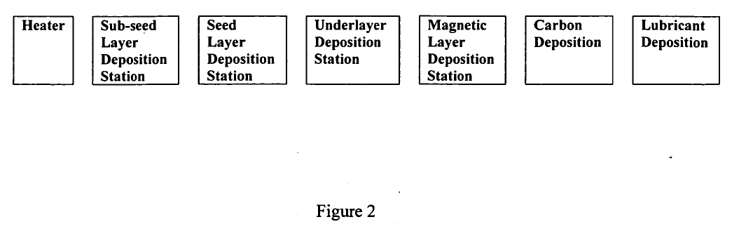

An inline process for manufacturing magnetic recording media is schematically illustrated in FIG. 2. The disc substrates travel sequentially from the heater to a sub-seed layer deposition station and a sub-seed layer is formed on the disc substrates. Then, the disc substrates travel to a seed layer station for deposition of the seed layer, typically NiAl. Subsequent to the deposition of the sub-seed layer and the seed layer, the disc substrates are passed through the underlayer deposition station wherein the underlayer is deposited. The discs are then passed to the magnetic layer deposition station and then to the protective carbon overcoat deposition station. Finally, the discs are passed through a lubricant film deposition station.

Sputtering leads to some particulates formation on the post sputter disks. These particulates need to be removed to ensure that they do not lead to the scratching between the head and substrate. Thus, a lube is preferably applied to the substrate surface as one of the top layers on the substrate.

The embodiments of the invention include sequential carbon deposition in a first process chamber, then vacuum deposition of lubricant in separate chamber (according to the method described in U.S. Pat. No. 6,183,831, incorporated herein by reference), followed by UV cure, in vacuum, in a sequential chamber, followed by unload of the discs from the in line deposition system. The embodiments of the invention could also include an off line vacuum system that is separate from the metal and carbon in-line system, and which could preferably only do sequential vacuum deposition of lubricant followed by vacuum UV cure, followed by vent and unload.

Subsequently, the disk is prepared and tested for quality thorough a three-stage process. First, a burnishing head passes over the surface, removing any bumps (asperities as the technical term goes). The glide head then goes over the disk, checking for remaining bumps, if any. Finally the certifying head checks the surface for manufacturing defects and also measures the magnetic recording ability of the substrate.

The lubricant moieties include polyfluoroether compositions that may be terminally functionalized with polar groups, such as hydroxyl, carboxy, or amino. The polar groups provide a means of better attaching or sticking the lubricant onto the surface of the recording media. These fluorinated oils are commercially available under such trade names as Fomblin Z®, Fomblin Z-Dol®, Fomblin Ztetraol®, Fomblin Am2001®, Fomblin Z-DISOC® (Montedison); Demnum® (Daikin) and Krytox® (Dupont).

The chemical structures of some of the Fomblin lubricants are shown below.
X—CF₂—[(OCF₂—CF₂)ₘ—(OCF₂)ₙ]—OCF₂—X
Fomblin Z: Non-reactive end groups
X=F
Fomblin Zdol: Reactive end groups
X=CH₂—OH
Fomblin AM2001: Reactive end groups 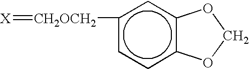
Fomblin Ztetraol: Reactive end groups

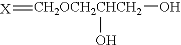

X1p is the most widely used lubricant additive for thin film storage medium. X-1P is available from the Dow Chemical Company. It has the formula:

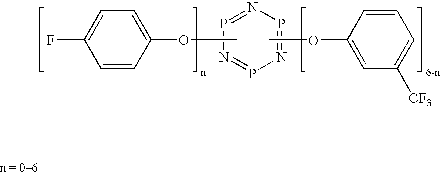

### DOW Chemicals X-1p (Cyclotriphosphazene Lubricant)

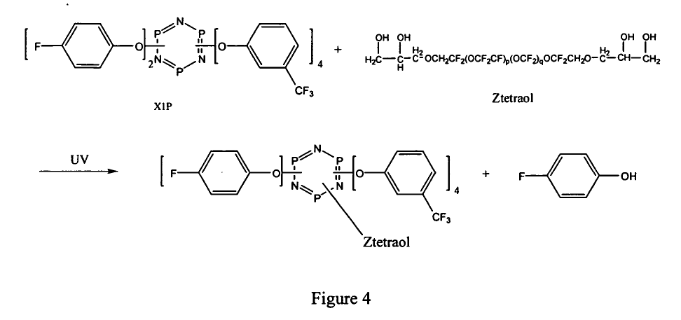

The most remarkable benefit from X1p application is the significant improvement of durability of storage medium. However, the durability benefit of X1p could be accompanied by potential problems, such as X1p phrase separation, head smear and lubricant pickup due to the limited miscibility of X1p in PFPE lubricant. Chemically linking lubricant molecules, such as Zdol, to the cyclotriphosphazene moiety could eliminate the low miscibility problems between lubricant and X1p. However, UV light could activate X1p very effectively. The fluorophenol and trifluoromethylphenol substituents on the cyclotriphosphazene ring in X1p could be excited readily by UV exposure. A sequence of photochemical reactions could be triggered, involving shedding of the fluorophenol and trifluoromethylphenol substituents from the cyclotriphosphazene ring. In the case that PFPE lubricants are presented in the reaction system, the hydroxyl end-group from the lubricant could combine with the activated cyclotriphosphazene ring and form molecules with desirable structure as shown in FIG. 4.

The additive moieties that could be added to the lubricant moieties in this invention include X1p and its derivatives. Also, adding a UV curable end group to the main lubricant further dramatically decreases the time to saturation. For example, the following UV curable compounds work with Z-DOL: acrylate, methacrylate, styrene, a-methyl styrene and vinyl ester.

The UV curable end group may be added to Z-DOL by reacting it with Acrylic chloride in the following reaction:

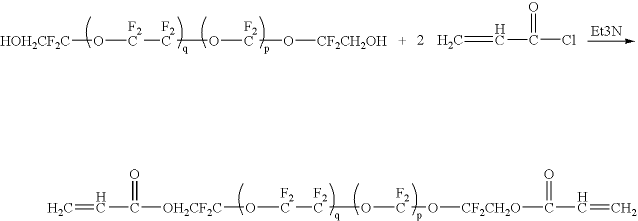

In addition to an acrylate functional group, other polymerizable functional groups including methacrylate, vinyl ester and 4-vinylbenzylate can also serve the purpose of providing a UV-curable functional end group. Those of ordinary skill may vary the particular ultraviolet wavelengths and UV-curable end groups according to the specific application which includes lubricant other than Z-DOL without varying from the scope of the invention as defined in the appended claims.

The thickness of the lubricant coating should be at least 0.5 nm, preferably at least 1 nm, and more preferably at least 1.2 nm and will generally be below 3 nm, preferably in the range from 1 nm to 3 nm. Molecular weight components of particular interest that provide higher film thickness range from 1 kD to 10 kD, preferably from 2 kD to 8 kD.

One way of describing a distribution of molecular components of a polymer, i.e., polydispersity, is to compare the weight average molecular weight defined as
M_{w}=ΣmᵢMᵢ/Σmᵢ
where mᵢ is the total mass of molecular component in the polymer having a molecular weight Mᵢ, with the number average molecular weight defined as
Mₙ=ΣNᵢMᵢ/ΣNᵢ
where Nᵢ is the total number of each molecular component in the polymer having a molecular weight Mᵢ. The weight average molecular weight (M_{w}) of a polymer will always be greater than the number average molecular weight (Mₙ), because the later counts the contribution of molecules in each class Mᵢ and the former weighs their contribution in terms of their mass. Thus, those molecular components having a high molecular weight contribute more to the average when mass rather than number is used as the weighing factor.

For all polydisperse polymers the ratio M_{w}/Mₙis always greater than one, and the amount by which this ratio deviates from one is a measure of the polydispersity of the polymer. The larger the M_{w}/Mₙ, ratio the greater the breadth of the molecular weight distribution of the polymer.

The molecular weight distribution of the vapor phase can be sampled by condensation of the vapor onto a suitable surface, followed by analysis of the condensate in a calibrated size exclusion chromatography system.

It is desirable that the lubricant has a relatively narrow molecular weight distribution of molecular components. In practice, the narrower the distribution the easier it will be to maintain a steady-state concentration of one or more components in the vapor. For example, if the highest and lowest molecular weight components in the polymer have very similar molecular weights, their vapor pressures will also be very similar. On the other hand, if the molecular weights (vapor pressures) are dramatically different heating of the lubricant will require much greater temperature and process control for a steady state concentration to be maintained. The lubricant used in the invention should have an M_{w}/Mₙ ratio between 1 and 1.6, preferably between 1 and 1.3, more preferably between 1 and 1.2.

The invention can be practiced with any commercial lubricant with a relatively large or small polydispersity, or with a lubricant that has been pre-fractionated to obtain a lubricant with a relatively small polydispersity. The preferred embodiment of the invention does not involve pre-fractionation of the lubricant. However, pre-fractionated lubricants may be used to provide relatively narrow molecular weight lubricant. If a pre-fractionated lubricant is used in the invention, distillation, chromatography, extraction, or other techniques that allow separation can obtain the pre-fractionated lubricant by molecular weight.

### EXAMPLES

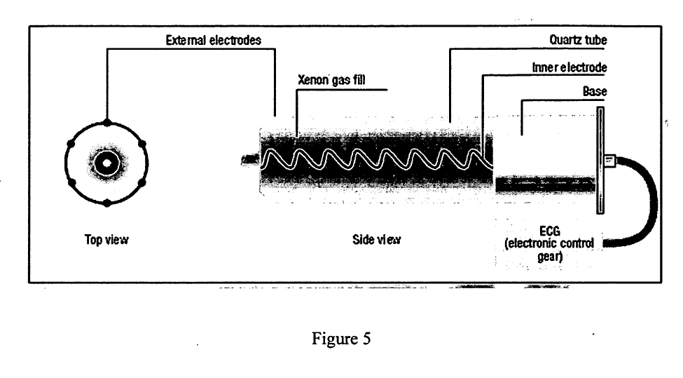

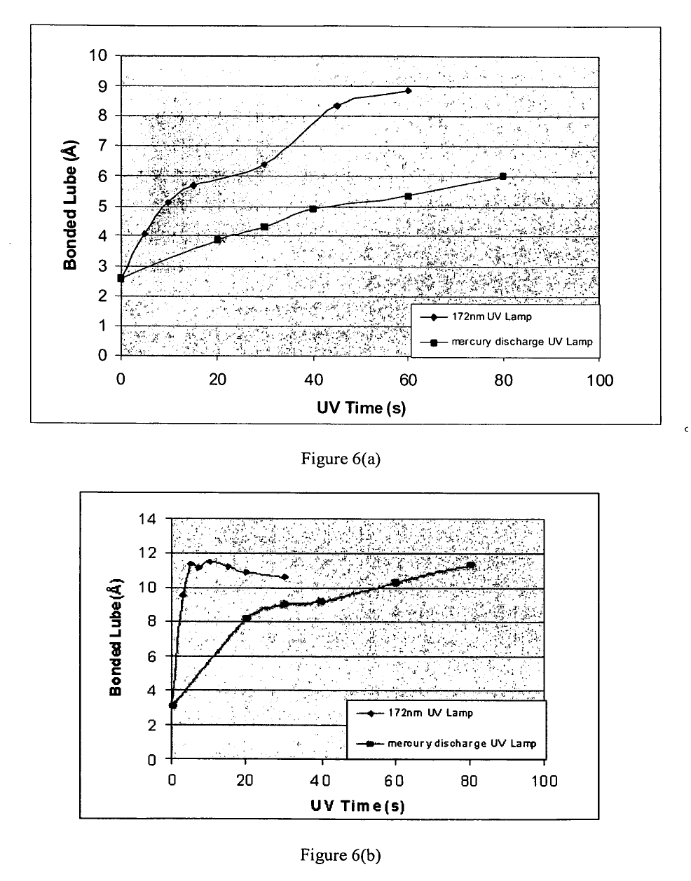

FIG. 5 shows an example of an excimer UV lamp (Osram GmbH, Munich Germany). A similar lamp from another manufacturer was used to collect data at ambient pressure on the bonding efficiency and operating characteristics of the lamp. FIG. 6(a) and FIG. 6(b) shows a comparison of the lubricant bonding rate for an excimer lamp and a mercury discharge lamp. The media used and the UV exposure conditions for evaluating the lubricant bonding rate using the excimer lamp and the mercury discharge lamp were the same with the lubricant system being a fractionated Zdol and X1P in FIG. 6(a) and Ac-Zdol in FIG. 6(b). Ac/Zdol is the lubricant with a UV active acrylate group as described above and here. Preferably, in Ac/Zdol, the UV curable end group may be added to Z-DOL by reacting it with Acrylic chloride in the following reaction:

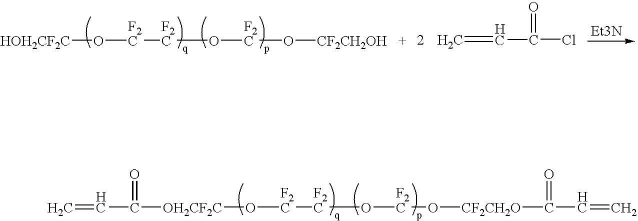

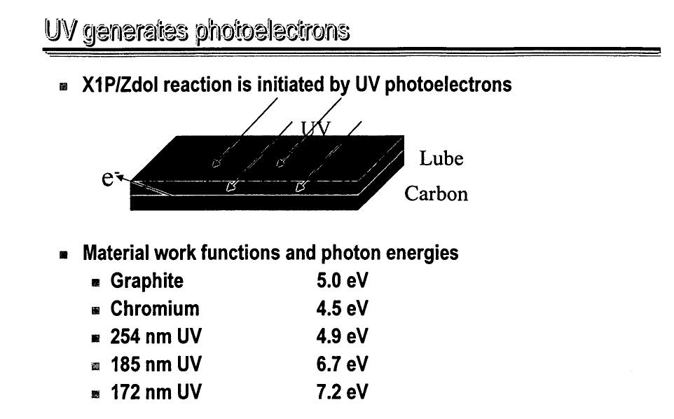

At ambient nitrogen pressure the bonding rate for the excimer lamp in this experiment was roughly a factor of four and ten higher than for the mercury discharge lamp using the lubricant system RMW/X1P and Ac-Zdol, respectively. The efficiency of the excimer lamp is expected to further increase when operated in a vacuum environment. FIG. 7 shows the generally accepted mechanism for the UV bonding of lubricant to a carbon overcoat. Because perfluoropolyether (PFPE) lubricants are transparent to UV, an alternative to direct photoexcitation of the lubricant is necessary to account for the observed chemistry. In this proposed mechanism, low energy photoelectrons are ejected from the substrate by UV photons with energy higher than the substrate's surface work function. PFPE lubricants have been shown to have high cross sections for capture of low energy electrons, and the bonding process is thought to proceed through chemistry initiated by decay of the resultant PFPE negative ions. Additional experiments have shown that lubricant bonding can be achieved directly with a low energy electron beam, lending support to this mechanism. The energies of the 172 nm excimer lamp and of the 185 nm band of the mercury discharge lamp are both sufficient to overcome the work function of the carbon overcoat, while the bulk of the power of the mercury discharge lamp at 254 nm is very near the threshold for photoelectron generation.

In this application, the word “containing” means that a material comprises the elements or compounds before the word “containing” but the material could still include other elements and compounds. This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein, Finally, the entire disclosure of the patents and publications referred in this application are hereby incorporated herein by reference.

What is claimed is:

1. A system comprising a deposition chamber comprising a xenon excimer lamp and an inlet for deposition of a lubricant into the deposition chamber, wherein the deposition chamber has an ability to perform both a vapor deposition of the lubricant and an in-situ UV exposure of the lubricant.

2. The system of claim 1, further comprising a source chamber, wherein the source chamber communicates with the deposition chamber.

3. The system of claim 1, wherein the xenon excimer lamp produces more than 25% of the power at a wavelength of 185 nm or less.

4. The system of claim 1, wherein the xenon excimer lamp operates under a vacuum.

5. The system of claim 1, wherein the system does not include purging with a coolant to cool the xenon excimer lamp.

6. The system of claim 1, wherein the deposition chamber is under a vacuum.

7. A method comprising depositing a lubricant on a magnetic recording medium in a deposition chamber and in-situ UV exposing of the lubricant to irradiation from a xenon excimer lamp.

8. The method of claim 7, further comprising providing the lubricant from a source chamber to the deposition chamber, wherein the source chamber communicates with the deposition chamber.

9. The method of claim 8, further comprising evacuating the deposition chamber and the source chamber with a vacuum source to a pressure below atmospheric.

10. The method of claim 9, further comprising heating the lubricant in the source chamber so that the pressure in the source chamber is greater than the pressure in the deposition chamber.

11. The method of claim 10, wherein the depositing the lubricant on the magnetic recording medium in the deposition chamber comprises exposing the magnetic recording medium in the deposition chamber to the lubricant for a time sufficient to deposit the lubricant topcoat on the surface of the magnetic recording medium.

12. The method of claim 11, wherein the depositing the lubricant on the magnetic medium in the deposition chamber is at a pressure no greater than about 100 Torr.

13. The method of claim 12, further comprising heating the lubricant in the source chamber and comprising controlling the flow of the lubricant between the source chamber and the deposition chamber with a controller valve.

14. The method of claim 7, wherein the xenon excimer lamp produces more than 35% of the power at a wavelength of 185 nm or less.

15. A method comprising irradiating a lubricant film with UV radiation emitted from a xenon excimer lamp and having a wavelength corresponding to a wavelength of maximum absorption of UV radiation by the lubricant film, wherein the lubricant thin film comprises at least one perfluoropolyether compound and a phosphazene derivative.

16. The method as in claim 15, wherein the lubricant thin film is formed on a surface of a data/information storage and retrieval medium.

17. The method as in claim 16, wherein the data/information storage and retrieval medium is a disk-shaped magnetic or magneto-optical (MO) recording medium.

18. The method as in claim 17, wherein the medium comprises a layer stack formed on a substrate surface, the layer stack including an uppermost, carbon (C)-containing protective overcoat layer, and the lubricant thin film is in the form of a topcoat layer in overlying contact with the carbon (C)-containing protective overcoat layer.

19. The method as in claim 15, wherein the phosphazene derivative is bis (4-fluorophenoxy)-tetrakis (3-trifluoromethyl phenoxy) cyclo-triphosphazene.

20. The method as in claim 15, further comprising varying the wavelength of maximum absorption of UV radiation by the lubricant thin film by varying the temperature of the lubricant thin film during irradiation.
